(19) United States
(12) Patent Application Publication
(10) Pub. No.: US 2024/0185558 A1
(43) Pub. Date: Jun. 6, 2024

(54) IMAGE SIGNAL PROCESSOR AND IMAGE SENSING DEVICE THEREOF

(71) Applicant: Samsung Electronics Co., Ltd., Suwon-si (KR)

(72) Inventors: Chang Hoon CHOI, Suwon-si (KR); Dong-Bum CHOI, Suwon-si (KR); Hyun Yup KWAK, Suwon-si (KR); Seung Won CHOI, Suwon-si (KR)

(73) Assignee: Samsung Electronics Co., Ltd., Suwon-si (KR)

(21) Appl. No.: 18/513,871

(22) Filed: Nov. 20, 2023

(30) Foreign Application Priority Data
Dec. 2, 2022 (KR) 10-2022-0166542

(51) Int. Cl. G06V 10/56; G06T 5/00; G06T 7/90; G06V 10/75; H04N 1/60

(52) U.S. Cl. CPC G06V 10/56; G06T 5/005; G06T 7/90; G06V 10/751; H04N 1/60; G06T 2207/10024

(57) ABSTRACT

An image sensing device including an image sensor configured to output a raw image by capturing an image of a subject and an image signal processor configured to perform a bad pixel correction process on the raw image on an image patch-by-image patch unit, compare pixels of an image patch of the raw image with a local saturation threshold value, determine a state of local saturation of the image patch based on a number of saturated pixels whose pixel values exceed the local saturation threshold value, and output a corrected image patch, which is obtained by correcting a pixel of the image patch with a corrected pixel value, with a replacement pixel value, or with a raw pixel value depending on the state of local saturation of the image patch.

### CROSS-REFERENCE TO RELATED APPLICATION

This application claims priority from Korean Patent Application No. 10-2022-0166542 filed on Dec. 2, 2022 in the Korean Intellectual Property Office, and all the benefits accruing therefrom under 35 U.S.C. 119, the contents of which in its entirety are herein incorporated by reference.

### BACKGROUND

### 1. Field

The present disclosure relate to image signal processors.

### 2. Description of the Related Art

Image sensing devices may be used in mobile devices such as smartphones, tablet personal computers (PCs), or digital cameras or in various electronic devices. The image sensing devices, which have a structure in which fine pixels are two-dimensionally integrated, convert electrical signals corresponding to the brightness of light incident thereupon into digital signals and output the digital signals. The image sensing devices include analog-to-digital converters (ADCs) to convert analog signals corresponding to the brightness of light into digital signals.

Meanwhile, examples of image sensors include charge-coupled devices (CCDs) and complementary metal-oxide semiconductor (CMOS) image sensors (CISs). The CCDs have less noise than the CISs and provide more excellent image quality than the CMOS image sensors. The CISs can be driven by a simple driving method and can be implemented in various scanning methods. Also, as the CISs allow signal processing circuitry to be integrated into a single chip, the CISs can be miniaturized and can be fabricated at low cost because of the interchangeability of CMOS technology. Also, the CISs have very low power consumption and are thus easily applicable to mobile devices.

The CISs may include a plurality of pixels that are arranged two-dimensionally. Each of the pixels may include, for example, a photodiode (PD), which converts incident light into an electrical signal.

In accordance with recent developments in the computer and communications industries, the demand for image sensors with improved performance has increased in various fields such as the fields of digital cameras, camcorders, smart phones, game devices, security cameras, medical micro cameras, and robots.

### SUMMARY

Aspects of the present disclosure provide image sensing devices with improved image quality.

However, aspects of the present disclosure are not restricted to those set forth herein. The above and other aspects of the present disclosure will become more apparent to one of ordinary skill in the art to which the present disclosure pertains by referencing the detailed description of the present disclosure given below.

According to some aspects of the present disclosure, there is provided an image sensing device including an image sensor configured to output a raw image by capturing an image of a subject and an image signal processor configured to perform a bad pixel correction process on the raw image on an image patch-by-image patch unit, compare pixels of an image patch of the raw image with a local saturation threshold value, determine a state of local saturation of the image patch based on a number of saturated pixels whose pixel values exceed the local saturation threshold value, and output a corrected image patch, which is obtained by correcting a pixel of the image patch with a corrected pixel value, with a replacement pixel value, or with a raw pixel value depending on the state of local saturation of the image patch.

According to some aspects of the present disclosure, there is an operating method of an image signal processor, the method including receiving a raw image and image information regarding the raw image from an image sensor, generating corrected pixel values by performing bad pixel correction on the raw image on an image patch-by-image patch basis, determining a state of local saturation of an image patch of the raw image correcting the image patch with the corrected pixel values, with a replacement pixel value, or with raw pixel values depending on the state of local saturation of the image patch and outputting the corrected image patch.

According to some aspects of the present disclosure, there is an image signal processor including a pixel corrector configured to perform a bad pixel correction process on a raw image on an image patch-by-image patch basis, a local saturation monitor configured to determine a state of local saturation of an image patch of the raw image based on a number of saturated pixels and store location information of the saturated pixels and a color distortion restorer configured to output a corrected image patch by correcting pixel values of the saturated pixels with a replacement pixel value or with raw pixel values.

It should be noted that the effects of the present disclosure are not limited to those described above, and other effects of the present disclosure will be apparent from the following description.

### BRIEF DESCRIPTION OF THE DRAWINGS

The above and other aspects and features of the present disclosure will become more apparent by describing in detail some example embodiments thereof with reference to the attached drawings, in which:

FIG. 1 is a block diagram of an image sensing device according to some example embodiments of the present disclosure.

FIG. 2 illustrates a raw image to be processed by the image sensing device of FIG. 1.

FIGS. 3 through 5 illustrate pixel arrays according to some example embodiments of the present disclosure.

FIG. 6 is a block diagram of an ISP according to some example embodiments of the present disclosure.

FIG. 7 is a flowchart illustrating an operating method of the ISP 100 according to some example embodiments of the present disclosure.

FIG. 8 is a flowchart illustrating a pixel correction method of the ISP 100 according to some example embodiments of the present disclosure.

FIG. 9 is a flowchart illustrating a raw saturation monitoring method of the ISP 100 according to some example embodiments of the present disclosure.

FIG. 10 is a flowchart illustrating a color distortion correction method of the ISP 100 according to some example embodiments of the present disclosure.

FIG. 11 is a block diagram of an electronic device including multiple camera modules, according to some example embodiments of the present disclosure.

FIG. 12 is a detailed block diagram of a camera module of FIG. 11 according to some example embodiments of the present disclosure.

### DETAILED DESCRIPTION

In the present disclosure, “units”, “modules”, or functional blocks may be implemented as hardware, software, or a combination thereof.

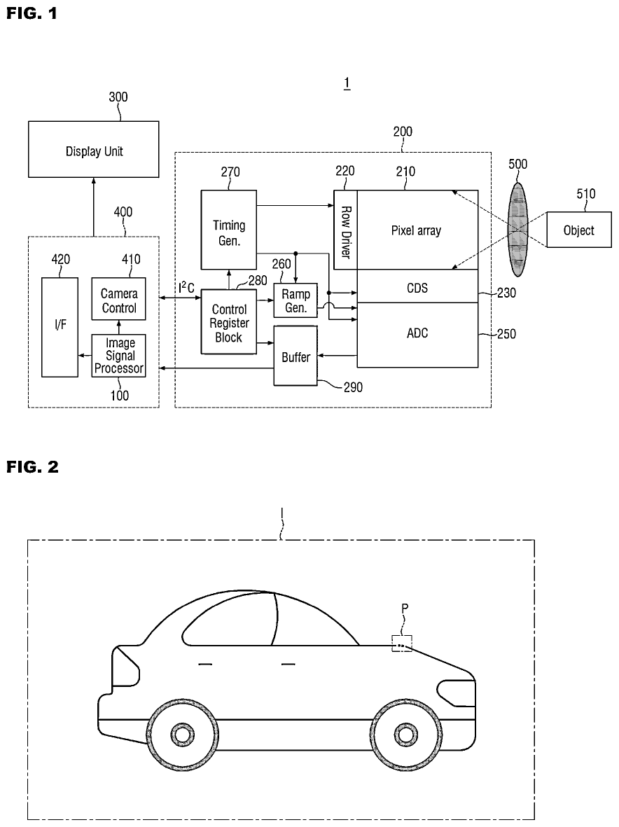

FIG. 1 is a block diagram of an image sensing device according to some example embodiments of the present disclosure.

Referring to FIG. 1, an image sensing device 1 may be implemented as a portable electronic device such as, for example, a digital camera, a camcorder, a mobile phone, a smartphone, a tablet personal computer (PC), a personal digital assistant, a mobile Internet device (MID), a wearable computer, an Internet-of-Things (IoT) device, and/or an Internet-of-Everything (IoE) device.

The image sensing device 1 may include a display unit 300, a digital signal processor (DSP) 400, and an image sensor 200. The image sensor 200 may be, for example, a complementary metal-oxide semiconductor (CMOS) image sensor (CIS).

The image sensor 200 includes a pixel array 210, a row driver 220, a correlated double sampling (CDS) block 230, an analog-to-digital converter (ADC) 250, a ramp generator 260, a timing generator 270, a control register block 280, and a buffer 290.

The image sensor 200 may sense an object 510 captured by a lens 500, under the control of the DSP 150, and the DSP 400 may output an image sensed and output by the image sensor 200, to the display unit 300.

The image sensor 200 may receive a raw image from the pixel array 210, may analog binning on the raw image via the ADC 250 and the buffer 290, and may output the binned image to the DSP 400.

The display unit 300 may be a device capable of outputting or displaying an image. For example, the display unit 300 may refer to a computer, a mobile communication device, and another image output terminal.

The DSP 400 includes a camera control 410, an image signal processor (ISP) 100, and an interface (I/F) 420.

The camera control 410 controls the operation of the control register block 280. The camera control 410 may control the operation of the image sensor 200, particularly, the operation of the control register block 280, using an inter-integrated circuit (I²C), but the present disclosure is not limited thereto.

The ISP 100 receives image data output from the buffer 290, processes the received image to be favorable to look at, and outputs the processed image data to the display unit 300 via the I/F 420.

In some example embodiments, the ISP 100 may process image data output from the image sensor 200. The ISP 100 may output a digital-binned image to the display unit 300 as a final binned image. The image output from the image sensor 200 may be the raw image from the pixel array 210 or may be a binned image. For convenience, the image sensor 200 will hereinafter be described simply as outputting image data.

The ISP 100 is illustrated as being positioned in the DSP 400, but the present disclosure is not limited thereto. Alternatively, the ISP 100 may be positioned in the image sensor 200. Alternatively, the image sensor 200 and the ISP 100 may be incorporated into a single package, for example, a multichip package (MCP).

The pixel array 210 may include a plurality of pixels that are arranged in a matrix. Each of the pixels includes a light-sensing element (or a photoelectric conversion element) and a read-out circuit, which outputs a pixel signal (e.g., an analog signal) corresponding to charges generated by the light-sensing element. The light-sensing element may be implemented as, for example, a photodiode (PD) or a pinned PD.

The row driver 220 may activate each of the pixels. For example, the row driver 220 may drive the pixels of the pixel array 210 in units of rows. For example, the row driver 220 may generate control signals for controlling pixels included in each of the rows.

Pixel signals output from the pixels may be transmitted to the CDS block 230 in accordance with the control signals generated by the row driver 220.

The CDS block 230 may include a plurality of CDS circuits. The CDS circuits may perform CDS on pixel values output from a plurality of column lines of the pixel array 210, in response to at least one switch signal output from the timing generator 270, may compare the sampled pixel signals and a ramp signal Vramp output from the ramp generator 260, and may output a plurality of comparison signals.

The ADC 250 may convert the comparison signals into digital signals and may output the digital signals to the buffer 290.

The ramp generator 260 outputs the ramp signal Vramp to the CDS block 230. The ramp signal Vramp may ramp from a reference level to be compared with a reset signal Vrst, rise to the reference level, and may ramp again from the reference level to be compared with an image signal Vim.

The timing generator 270 may control the operations of the row driver 220, the ADC 250, the CDS block 230, and the ramp generator 260 under the control of the control register block 280.

The control register block 280 controls the operations of the timing generator 270, the ramp signal generator 260, and the buffer 290 under the control of the DSP 400.

The buffer 290 may transmit pixel data corresponding to a plurality of digital signals (or pixel array ADC output) from the ADC 250 to the DSP 400. The pixel data output from the pixel array 210 through the CDS block 230 and the ADC 250 may be a raw image, particularly, a Bayer image having a Bayer format.

In some example embodiments, the ISP 100 may receive a raw image from the image sensor 200, may process the received raw image, and may output the processed raw image. For example, the operation of the ISP 100 may be comprises a pre-ISP chain (or preprocessing) and an ISP chain (or postprocessing). Image processing before demosaicing may refer to preprocessing, and image processing after demosaicing may refer to postprocessing. For example, a preprocessing process of the ISP 100 may include 3A processing, lens shading correction, edge enhancement, and/or bad pixel correction. Here, the 3A processing may include at least one of auto white balance (AWB), auto exposure (AE), and auto focusing (AF). For example, a postprocessing process of the ISP 100 may include at least one of changing indexes, which are sensor values, changing tuning parameters, and adjusting screen ratio. The postprocessing process includes adjusting at least one of the contrast, sharpness, saturation, and dithering of a preprocessed image. Here, contrast, sharpness, and saturation adjustment procedures may be performed in a YUV color space (for example, defining one luminance component (Y) meaning physical linear-space brightness, and two chrominance components, for example U (blue projection) and V (red projection)), and a dithering procedure may be performed in a red-green-blue (RGB) color space. In some example embodiments, part of the preprocessing process may be performed during the postprocessing process, and part of the postprocessing process may be performed during the preprocessing process. In some example embodiments, part of the preprocessing process may overlap with part of the postprocessing process.

The ISP 100 scans a raw image I on an image patch-by-image patch basis and performs bad pixel detection and local saturation monitoring on a scanned image patch Pi of the raw image I. A current image patch, e.g., an image patch currently being scanned, may be independent from a subsequent image patch to be scanned next, and the result of signal processing performed on a previous image patch does not affect signal processing performed on the current image patch.

That is, if the raw image I is an M×N pixel array and the image patch Pi has a size of a×b pixels (where M>>a and N>>b), image patches are continuously set so that all the pixels of the raw image I, ranging from the pixel in the first row and the first column of the raw image I to the pixel in the last row and the last column of the raw image I, become the center pixels of their respective image patches.

The ISP 100 performs bad pixel detection on the image patch Pi and performs pixel correction on bad pixels detected from the image patch Pi. The ISP 100 may compare the pixels of the image patch Pi with a predefined or, alternatively, selected, or desired saturation threshold value THₛₐₜ and may perform partial color restoration depending on the number of saturated pixels, which are pixels whose pixel values exceed the saturation threshold value THₛₐₜ.

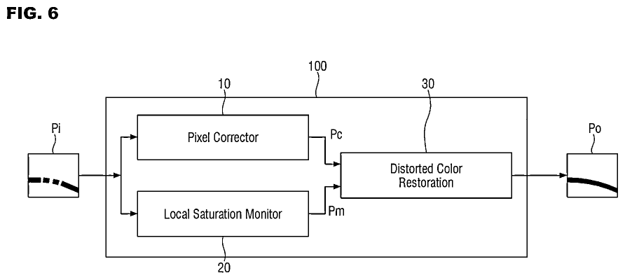

Partial color restoration corrects the saturated pixels with a replacement pixel value, rather than with a corrected pixel value. For example, the pixel values of only center pixels may be corrected, or raw pixel values may be restored depending on the number of saturated pixel values. The ISP 100 may perform partial color restoration on locally saturated pixels in a pixel-corrected image patch where color distortion has occurred, and may thus output a corrected image patch Po. The operation of the ISP 100 will be described later in further detail with reference to FIG. 6.

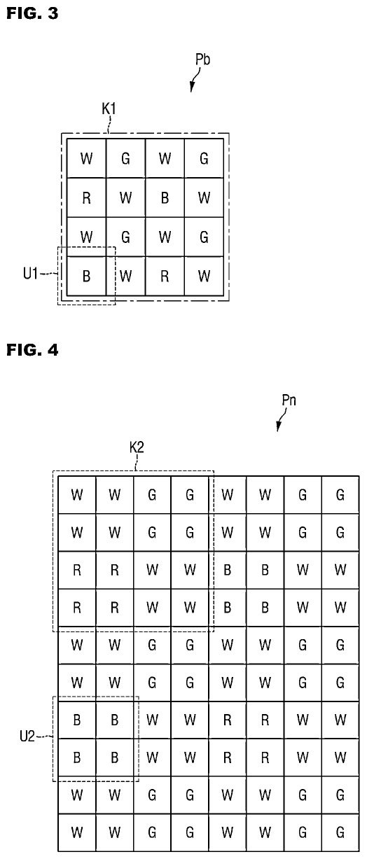

FIG. 2 illustrates a raw image to be processed by the image sensing device of FIG. 1.

Referring to FIG. 2, it is assumed that the ISP 100 processes the entire raw image I. For example, the ISP 100 stores the raw pixel values of the pixels of the raw image I and performs bad pixel correction by scanning the raw image I on an image patch P—by image patch P basis. Here, each image patch P may include locally saturated pixels that may be generated by pixel correction.

For example, when the ISP 100 performs pixel correction on each of the image patches, color distortion, which is a phenomenon in which some pixels do not match their neighboring pixels, may occur.

Even if color distortion occurs due to pixel correction, separate processing may be performed on local areas to improve the quality of an image. That is, the ISP 100 may generate a corrected image by performing processing, including both pixel correction for the entire raw image I and pixel restoration for local areas. The corrected image may be output to the display unit 300.

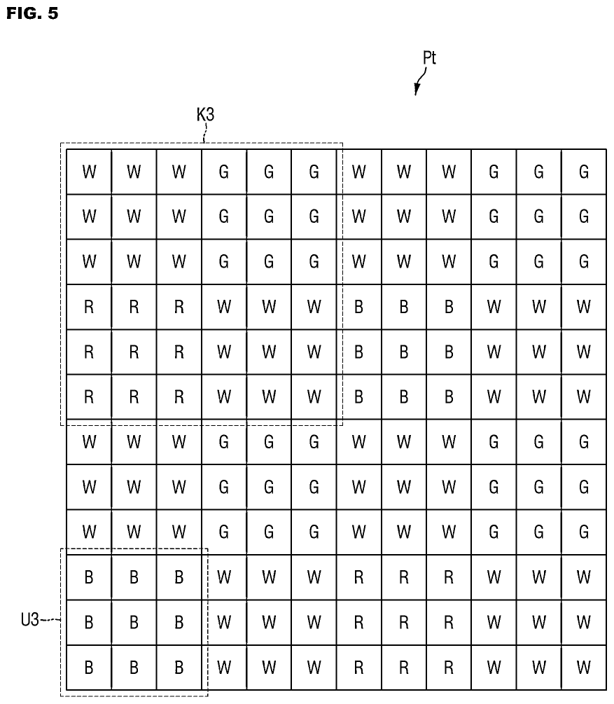

FIGS. 3 through 5 illustrate pixel arrays according to some example embodiments of the present disclosure.

In some example embodiments, the pixel array 210 may have a Bayer pattern.

A raw image may be processed in units of kernels K1 corresponding to an image patch Pb. A kernel K1 may include at least two red pixels R, at least four green pixels G, at least six white pixels W, and at least two blue pixels B and may also be referred to as a window, a unit, or a region of interest (ROI).

Referring to FIG. 3, a Bayer pattern may include, in one unit pixel group, a first row in which white pixels W and green pixels G are alternately arranged, a second row in which a red pixel R, a white pixel W, a blue pixel B, and a white pixel W are sequentially arranged, a third row in which white pixels W and green pixels G are alternately arranged, and a fourth row in which a blue pixel B, a white pixel W, a red pixel R, and a white pixel W are sequentially arranged. That is, color pixels U1 of various colors may be arranged in the Bayer pattern.

A kernel K1 of a pixel array 210a may have a 4×4 size, but the pixel array 210a may also be applicable to various other sizes of kernels.

Alternatively, the Bayer pattern may include, in one unit pixel group, a plurality of red pixels R, a plurality of blue pixels, a plurality of green pixels (Gr and Gb), and a plurality of white pixels W. That is, the color pixels U1 may be arranged in a 2×2 or 3×3 matrix.

Referring to FIG. 4, a kernel K2 of a pixel array 210b corresponding to at least a portion of an image patch Pn of a raw image may have a Bayer pattern in which color pixels are arranged in a tetra layout. That is, color pixels U2 of various colors may include 2×2 red pixels R, 2×2 green pixels G, 2×2 blue pixels, and 2×2 white pixels W.

Referring to FIG. 5, a kernel K3 of a pixel array 210c corresponding to at least a portion of an image patch Pt of a raw image may have a Bayer pattern in which color pixels are arranged in a nona layout. That is, color pixels U3 of various colors may include 3×3 red pixels R, 3×3 green pixels G, 3×3 blue pixels, and 3×3 white pixels W.

Although not for example illustrated, the unit kernel of the pixel array 210 may have a Bayer pattern in which N×N (where N is a natural number of 2 or greater) color pixels are arranged.

FIG. 6 is a block diagram of an ISP according to some example embodiments of the present disclosure.

Referring to FIG. 6, the ISP 100 receives a raw image I and processes the received raw image I. In some example embodiments, the ISP 100 may receive image information regarding the raw image I from the image sensor 200.

The image information may include at least one of, for example, local saturation threshold value information, saturation threshold quantity information, white balance information of the entire raw image I, location information of each image patch P of the raw image I, white balance information of each image patch P, corrected pixel values for the raw pixel values of pixels included in each image patch P, static bad pixel information, and phase detection auto focus (PDAF) location information.

In some example embodiments, at least some of the image information may be information stored as hardware register settings. Alternatively, in some example embodiments, the image information may be data calculated in accordance with a predefined or, alternatively, selected, or desired rule, based on sensing data from the image sensor 200. Alternatively, in some example embodiments, the image information may be data extracted from a mapping table, which is obtained by machine learning and in which a plurality of setting values are mapped to a plurality of environment values.

In some example embodiments, the ISP 100 may include a pixel corrector 10, a local saturation monitor 20, and a color distortion restorer 30.

The pixel corrector 10 may perform pixel correction on an image patch Pi of the raw image I. The image patch Pi may have different sizes depending on its kernel size. For example, if the image patch Pi has a kernel size (U1) of one color pixel, as illustrated in FIG. 3, the image patch Pi may have a size of 3×3 or a 5×5 pixels.

In some example embodiments, the pixel corrector 10 may perform dynamic bad pixel detection on the raw image I and may perform bad pixel correction on any detected bad pixels. Bad pixels may also be referred to as false pixels, dead pixels, or hot/cold pixels. The ISP 100 may perform partial color restoration on distorted pixels depending on the level of local saturation in a pixel-corrected image patch.

Pixel correction corrects the raw pixel values of bad pixels based on information (e.g., dynamic bad pixel information) extracted by the ISP 100 or information (e.g., bad pixel information, static bad pixel information, or phase detection pixel information received from the image sensor 200) received from outside the ISP 100 and may be performed in an interpolation method, a local normalization method, and/or an averaging method.

The local saturation monitor 20 performs local saturation monitoring to monitor whether the pixel values of the pixels included in the image patch Pi exceeds a local saturation level. For example, the local saturation monitor 20 compares the pixel values of the pixels of the image patch Pi with the predefined or, alternatively, selected, or desired saturation threshold value THₛₐₜ. Pixels having a pixel value greater than the predefined or, alternatively, selected, or desired saturation threshold value THₛₐₜ may be determined as being saturated pixels Pₛₐₜ, and pixels having a pixel value less than the predefined or, alternatively, selected, or desired saturation threshold value THₛₐₜ may be determined as being non-saturated pixels. The local saturation monitor 20 counts the number of saturated pixels Pₛₐₜ and compares the result of the counting, e.g., a saturated pixel count Num(Pₛₐₜ), with first and second threshold values TH1_{satNum} and TH2_{satNum}. The first threshold value TH1_{satNum} may be less than the second threshold value TH2_{satNum}.

For example, if the saturated pixel count Num(Pₛₐₜ) is greater than the second threshold value TH2_{satNum} (e.g., Num(Pₛₐₜ)>TH2_{satNum}), the local saturation monitor 20 determines that the image patch Pi is burnt. For example, if the saturated pixel count Num(Pₛₐₜ) is greater than the first threshold value TH1_{satNum} and is equal to, or less than, the second threshold value TH2_{satNum} (e.g., TH1_{satNum}<Num(Pₛₐₜ)≤TH2_{satNum}), the local saturation monitor 20 determines that the image patch Pi is locally saturated. For example, if the saturated pixel count Num(Pₛₐₜ) is less than the first threshold value TH1_{satNum} (e.g., TH1_{satNum}>Num(Pₛₐₜ)), the local saturation monitor 20 determines that the image patch Pi is not locally saturated.

The color distortion restorer 30 may either maintain a corrected pixel value for a current pixel or correct the pixel value of the current pixel with a replacement pixel value. For example, if the image patch Pi is determined as not being locally saturated, the color distortion restorer 30 may maintain a pixel value corrected by the pixel corrector 10 for the current pixel. For example, if the image patch Pi is determined as being locally saturated, if a center pixel P_{center} of the image patch Pi is a saturated pixel Pₛₐₜ (e.g., Current_Pₛₐₜ=P_{center}), the color distortion restorer 30 may correct the pixel value of the saturated pixel_{Psat} with a replacement pixel value CurP_{center}, rather than with a corrected pixel value. The replacement pixel value CurP_{center} may be obtained by multiplying a largest pixel value around the center pixel P_{center}, e.g., Max(P_{adj_center}), by the white balance ratio of the center pixel P_{center}, e.g., WhiteBalanceRatio_{center}, as indicated by Equation (1):

CurP_{center}=Max(P_{adj_center})×WhiteBalanceRatio_{center} (1).

For example, if the image patch Pi is determined as being burnt, the color distortion restorer 30 restores the pixel value of burnt pixels P_{Burnt} to corresponding raw pixel values Raw_P of the raw image I, received by the ISP 100, based on location information of the burnt pixels P_{Burnt}.

The color distortion restorer 30 may output a corrected image patch Po, which is a pixel-corrected image patch having a locally saturated pixel reflected therein. Each of the pixels of the image patch Po may be corrected with a corrected pixel value, a replacement pixel value, or a raw pixel value.

The correction of each pixel with, for example, a replacement pixel value or a raw pixel value, rather than with a corrected pixel value calculated via pixel correction, may also be referred to as pixel value restoration, rollback, or update, but the present disclosure is not limited thereto.

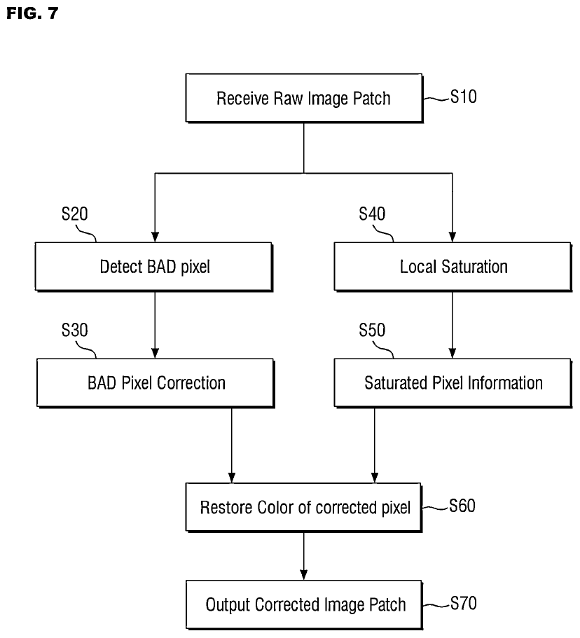

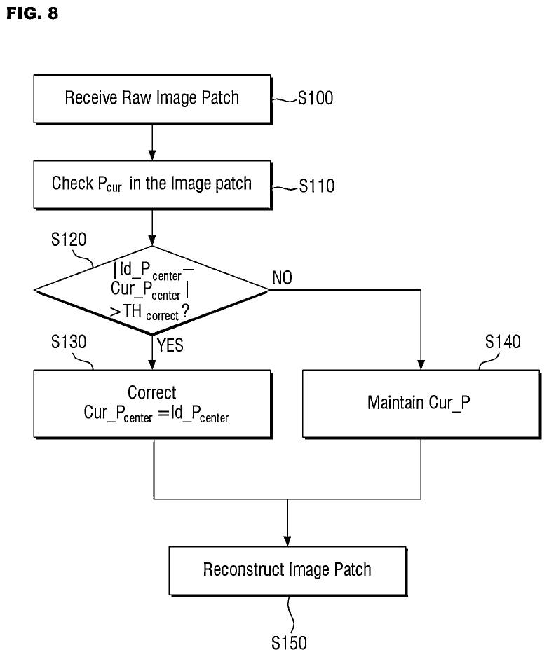

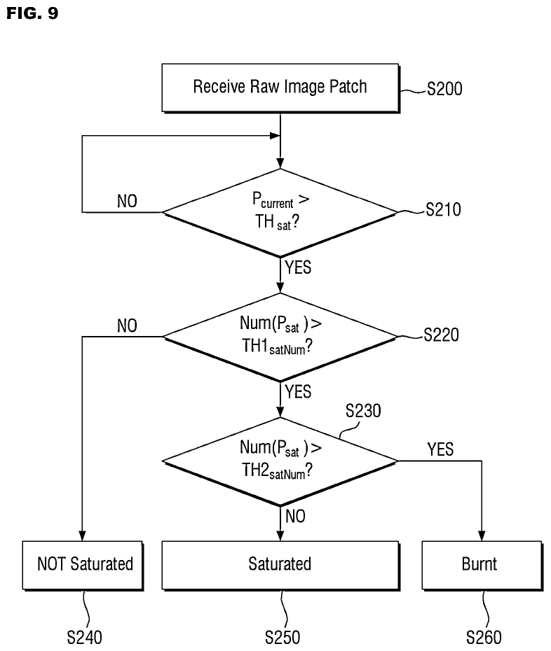

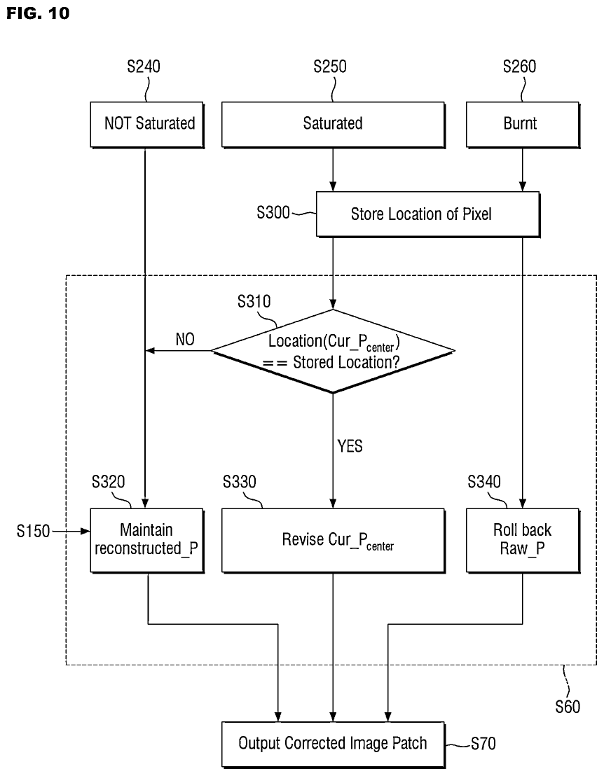

FIGS. 7 through 10 are flowcharts illustrating operations of the ISP 100 according to some example embodiments of the present disclosure. FIG. 7 is a flowchart illustrating an operating method of the ISP 100 according to some example embodiments of the present disclosure, FIG. 8 is a flowchart illustrating a pixel correction method of the ISP 100 according to some example embodiments of the present disclosure, FIG. 9 is a flowchart illustrating a raw saturation monitoring method of the ISP 100 according to some example embodiments of the present disclosure, and FIG. 10 is a flowchart illustrating a color distortion correction method of the ISP 100 according to some example embodiments of the present disclosure.

Referring to FIG. 7, the ISP 100 receives a raw image I, which consists of raw pixel values, and scans the raw image I in units of image patches having a predetermined or, alternatively, desired size (S10). That is, all pixels included in the raw image I may become the center pixels of their respective image patches and may thus be subjected to pixel correction or local saturation monitoring.

The ISP 100 may perform dynamic bad pixel detection on an image patch Pi of the raw image I (S20). The ISP 100 may detect bad pixels from the image patch Pi via dynamic bad pixel detection and may correct the image patch Pi (S30). The image patch Pi may have different sizes depending on its kernel size, as described above with reference to FIGS. 3 through 5. For example, if the image patch Pi has a kernel size (U1) of one color pixel, as illustrated in the image patch Pb of FIG. 3, the image patch Pi may have a predetermined or, alternatively, desired size of 3×3 or 5×5 pixels.

The ISP 100 may perform local saturation monitoring on the image patch Pi (S40). The ISP 100 may determine whether the image patch Pi is not locally saturated, locally saturated, or burnt by monitoring whether the pixels of the image patch Pi are saturated. Thereafter, the ISP 100 may store saturated pixel information such as, for example, location information of saturated pixels and the number of saturated pixels, in accordance with the result of the determination (S50).

The ISP 100 may correct a pixel-corrected image patch obtained in S30 with corrected pixel values obtained in S30, with a replacement pixel value, or with the raw pixel values based on the saturated pixel information stored in S50 (S60). The ISP 100 outputs a corrected image patch (S70) by reflecting the result of the correction in the pixel-corrected image patch.

In some example embodiments, for image processing procedures (including bad pixel correction and color distortion restoration) for the image patch Pi, the ISP 100 may further receive image information Info(Pi) regarding the raw image I.

The image information Info(Pi) may be information stored as hardware register settings, data calculated in accordance with a predefined or, alternatively, selected, or desired rule, based on sensing data from the image sensor 200, or data extracted from a mapping table, which is obtained by machine learning and in which a plurality of setting values are mapped to a plurality of environment values.

In some example embodiments, the ISP 100 may repeat S10, S20, S30, S40, S50, S60, and S70 for a subsequent raw image patch of the raw image I. A corrected image patch for a current raw image patch is independent from a corrected image path for the subsequent raw image patch, and the result of signal processing performed on a previous image patch does not affect signal processing performed on the current image patch.

S20 and S30 of FIG. 7 will hereinafter be described with reference to FIG. 8. Referring to FIG. 8, in response to the raw image I being received for pixel correction, the ISP 100 detects bad pixels on an image patch-by-image patch basis (S100). S100 may be the same as S10 of FIG. 7.

The pixel values of pixels included in the image patch Pi are identified (S110), and a determination is made as to whether bad pixels are included in the image patch Pi based on center pixel information of the image patch Pi. For example, if the difference between a current pixel value Cur_P_{center} of the center pixel of the image patch Pi and an ideal center pixel value Id_P_{center} is greater than a predefined or, alternatively, selected, or desired correction threshold value TH_{correct} (“YES” in S120), the ISP 100 determines that the image patch Pi needs, could benefit from, etc., pixel correction. For example, if the difference between a current pixel value Cur_P_{center} of the center pixel of the image patch Pi and the ideal center pixel value Id_P_{center} is equal to or less than the correction threshold value TH_{correct} (“NO” in S120), the ISP 100 determines that the image patch Pi does not need, would not benefit from, is below a correction threshold, etc., pixel correction. The ideal center pixel value Id_P_{center} and the correction threshold value TH_{correct} may be included in the image information Info(Pi) regarding the raw image I, received from the image sensor 200 or an external device.

If the image patch Pi is determined as needing, could benefit from, etc., pixel correction (“YES” in S120), the ISP 100 corrects the current pixel value Cur_P_{center} of the center pixel of the image patch Pi with the ideal center pixel value Id_P_{center} (S130). If the image patch Pi is determined as not being in need, would not benefit from, is below a correction threshold, etc., of pixel correction (“NO” in S120), the ISP 100 maintains current pixel values Cur_P of pixels including the center pixel of the image patch Pi (S140). The current pixel values Cur_P may be raw pixel values received in S100. The ISP 100 reconstructs the image patch Pi (S150) with corrected pixel values obtained in S130 or S140.

S40 and S50 of FIG. 7 will hereinafter be described with reference to FIG. 9. Referring to FIG. 9, in response to the raw image I being received for pixel correction, the ISP 100 detects bad pixels on an image patch-by-image patch basis (S200). S200 may be the same as S10 of FIG. 7. The pixel values of all pixels included in the image patch Pi are compared with a predefined or, alternatively, selected, or desired local saturation threshold value THₛₐₜ (S210).

If the pixel value of a current pixel exceeds the local saturation threshold value THₛₐₜ (e.g., P_{current}>THₛₐₜ) (“YES” in S210), the current pixel is classified as a saturated pixel Pₛₐₜ, and a saturated pixel count Num(Pₛₐₜ) is increased. The ISP 100 compares the saturated pixel count Num(Pₛₐₜ) with first threshold value TH1_{satNum} (S220) and second threshold value TH2_{satNum} (S230) in order to determine whether the image patch Pi is not saturated, saturated, or burnt. For example, the first threshold value TH1 satNum, which is a threshold value for determining whether each image patch is locally saturated, is less than the second threshold value TH2_{satNum}, which is a threshold value for determining whether each image patch is burnt by local saturation. Here, the local saturation threshold value THₛₐₜ, the first threshold value TH1_{satNum}, and the second threshold value TH2_{satNum} may be included in the image information Info(Pi) regarding the raw image I, received from the image sensor 200 or an external device. The local saturation threshold value THₛₐₜ, the first threshold value TH1_{satNum}, and the second threshold value TH2_{satNum} may be determined in consideration of the characteristics of the image patch Pi. For example, the local saturation threshold value THₛₐₜ, the first threshold value TH1_{satNum}, and the second threshold value TH2_{satNum} may differ between a monochromatic image patch and a stripe-pattern image patch or between an image patch from an image captured at night and an image patch from an image captured during the day.

If the saturated pixel count Num(Pₛₐₜ) is less than the first threshold value TH1_{satNum} (e.g., TH1_{satNum}>Num(Pₛₐₜ)), the ISP 100 may determine that the image patch Pi is not locally saturated (S240). If the saturated pixel count Num(Pₛₐₜ) is greater than the first threshold value TH1 satNum and is equal to, or less than, the second threshold value TH2 satNum (e.g., TH1_{satNum}<Num(Pₛₐₜ)≤TH2_{satNum}), the ISP determines that the image patch Pi is locally saturated (S250). If the saturated pixel count Num(Pₛₐₜ) is greater than the second threshold value TH2_{satNum} (e.g., Num(Pₛₐₜ)>TH2_{satNum}), the ISP 100 may determine that the image patch Pi is burnt (S260).

S60 and S70 of FIG. 7 will hereinafter be described with reference to FIG. 10. Referring to FIG. 10, the ISP 100 corrects the image patch Pi with corrected pixel values obtained by the pixel correction method of FIG. 8, with a replacement pixel value, or with the raw pixel values received in S10 of FIG. 10.

For example, if the image patch Pi is determined as being locally saturated (S250) or as being burnt (S260), the ISP 100 stores location information of saturation pixels of the image patch Pi (S300). If the image patch Pi is determined as not being locally saturated (S240), the ISP 100 corrects the image patch Pi with reconstructed pixel values reconstructed_P (S320), as described above with regard to S150 of FIG. 8.

If the image patch Pi is determined as being locally saturated (S250) and the center pixel of the image patch Pi is included in the location information stored in S300 (e.g., Location(Cur_P_{center}))=Stored Location) (S310), a pixel value Cur_P_{center} of the center pixel of the image patch Pi is corrected with a replacement pixel value (S330). In some example embodiments, the replacement pixel value may be obtained by multiplying the largest pixel value around the center pixel of the image patch Pi by the white balance ratio of the center pixel of the image patch Pi. The other pixels of the image patch Pi may be subjected to pixel correction, local saturation monitoring, and color distortion restoration when they become the center pixels of their respective image patches.

If the image patch Pi is determined as being burnt (S260), the ISP 100 restores the center pixel of the image patch Pi to a corresponding raw pixel value Raw_P (S340) based on the location information stored in S300.

The ISP 100 outputs a corrected image patch with corrected pixel values, a replacement pixel value, or raw pixel values reflected therein, by performing bad pixel correction or color distortion restoration on each of the pixels of the image patch Pi depending on the level of local saturation of the image patch Pi (S70). In this manner, the image sensing device 1 can provide an image with an improved quality by performing bad pixel correction on each image patch in accordance with the characteristics of the image, without distorting any locally saturated pixels.

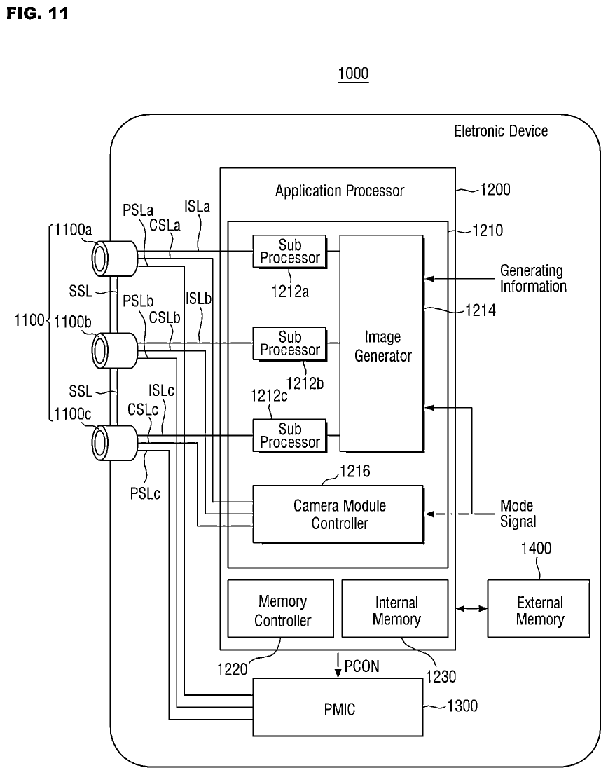

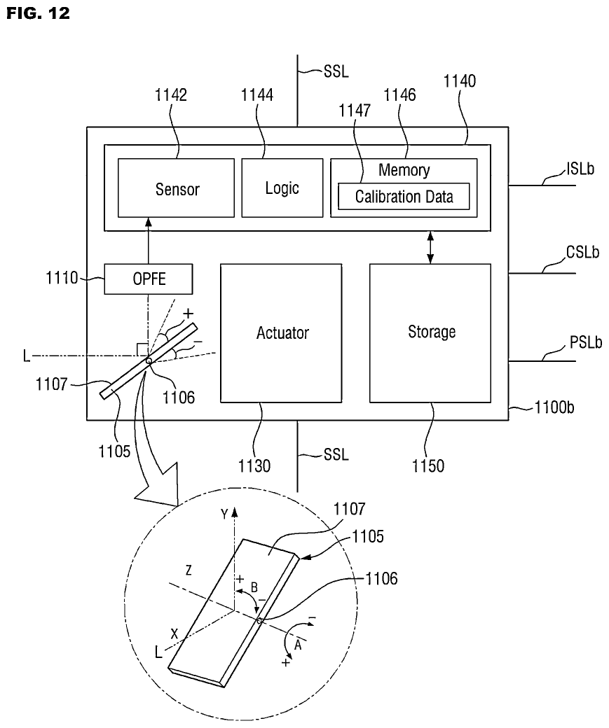

FIG. 11 is a block diagram of an electronic device including multiple camera modules, according to some example embodiments of the present disclosure. FIG. 12 is a detailed block diagram of a camera module of FIG. 11 according to some example embodiments of the present disclosure.

Referring to FIG. 11, an electronic device 1000 may include a camera module group 1100, an application processor 1200, a power management integrated circuit (PMIC) 1300, and an external memory 1400.

The camera module group 1100 may include a plurality of camera modules, for example, camera modules 1100a, 1100b, and 1100c. The camera module group 1100 is illustrated as including three camera modules, but the present disclosure is not limited thereto. Alternatively, the camera module group 1100 may be configured to include only two camera modules. Alternatively, the camera module group 1100 may be configured to include four or more camera modules.

The structure of the second camera module 1100b will hereinafter be described with reference to FIG. 12. The following description of the second camera module 1100b may be directly applicable to the camera modules 1100a and 1100c.

Referring to FIG. 12, the camera module 1100b may include a prism 1105, an optical path folding element (OPFE) 1110, an actuator 1130, an image sensing device 1140, and a storage 1150.

The prism 1105 may include a reflective surface 1107 of a light-reflecting material and may change the path of light L incident thereupon from outside.

In some example embodiments, the prism 1105 may change the path of light L incident thereupon in a first direction X into a second direction Y, which is perpendicular to the first direction X. The prism 1105 may rotate the reflective surface 1107 of the light-reflecting material in an A direction around a central shaft 1106 or may rotate the central shaft 1106 in a B direction to change the path of the light L from the first direction X to the second direction Y, which is perpendicular to the first direction X. In this case, the OPFE 1110 may move in a third direction X, which is perpendicular to both the first and second directions X and Y.

In some example embodiments, the maximum rotation angle of the prism 1105 may be 15 degrees or less, in a plus (+) A direction and may be greater than 15 degrees in a minus (−) A direction, but the present disclosure is not limited thereto.

In some example embodiments, the prism 1105 may move by an angle of about 20 degrees or an angle of about 10 degrees to about 20 degrees, or an angle of about 15 degrees to about 20 degrees in a minus B direction. In this case, the angle by which the prism 1105 moves in a plus B direction may be the same as, or similar (by as much as about one degree or less) to, the angle by which the prism 1105 moves in the minus B direction.

In some example embodiments, the prism 1105 may move the reflective surface 1107 of the light-reflecting material in the third direction X, which is parallel to the extension direction of the central shaft 1106.

The OPFE 1110 may include, for example, m optical lenses, where m is a natural number. The m lenses may move in the second direction Y and may change the optical zoom ratio of the second camera module 1100b. For example, when the default optical zoom ratio of the second camera module 1100b is Z, the optical zoom ratio of the second camera module 1100b may be changed to 3Z or to 5Z or greater by moving the m optical lenses of the OPFE 1110.

The actuator 1130 may move the OPFE 1110 or an optical lens (hereinafter, the optical lens) to a certain position. For example, the actuator 1130 may adjust the position of the optical lens such that an image sensor 1142 may be positioned at the focal length of the optical lens for an accurate sensing.

The image sensing device 1140 may include the image sensor 1142, a control logic 1144, and a memory 1146. The image sensor 1142 may sense an image of an object using the light L, which is provided through the optical lens. The control logic 1144 may control the general operation of the second camera module 1100b. For example, the control logic 1144 may control the operation of the camera module 1100b in accordance with control signals provided thereto through a control signal line CSLb.

The memory 1146 may store information, such as calibration data 1147, which is necessary for the operation of the second camera module 1100b. The calibration data 1147 may include information necessary for the second camera module 1100b to generate image data using the light L. For example, the calibration data 1147 may include degree-of-rotation information, focal length information, and optical axis information. When the second camera module 1100b is implemented as a multi-state camera whose focal length changes with the position of the optical lens, the calibration data 1147 may include focal lengths for different positions or states of the optical lens and/or auto focusing information.

The storage 1150 may store image data sensed by the image sensor 1142. The storage 1150 may be disposed outside the image sensing device 1140 and may form a stack with a sensor chip of the image sensing device 1140. In some example embodiments, the storage 1150 may be implemented as an electrically erasable programmable read-only memory (EEPROM), but the present disclosure is not limited thereto.

Referring to FIGS. 11 and 12, in some example embodiments, the camera modules 1100a, 1100b, and 1100c may include their respective actuators 1130. Accordingly, the camera modules 1100a, 1100b, and 1100c may include the same calibration data 1147 or different calibration data 1147 depending on the operation of their respective actuators 1130.

In some example embodiments, one of the camera modules 1100a, 1100b, and 1100c, for example, the second camera module 1100b, may be a folded lens-type camera module including the prism 1105 and the OPFE 1110, and the other camera modules, for example, the camera modules 1100a and 1100c, may be vertical camera modules not including the prism 1105 and the OPFE 1110. However, the present disclosure is not limited to this.

In some example embodiments, one of the camera modules 1100a, 1100b, and 1100c, for example, the camera module 1100c, may be a vertical depth camera extracting depth information using, for example, infrared ray (IR) light. In this case, the application processor 1200 may generate a three-dimensional (3D) depth image by merging image data received from the other camera modules, for example, the camera modules 1100a and 1100b.

In some example embodiments, at least two of the camera modules 1100a, 1100b, and 1100c, for example, the camera modules 1100a and 1100b, may have different fields of view. In this case, the camera modules 1100a and 1100b may have different optical lenses, but the present disclosure is not limited thereto.

Also, in some example embodiments, the camera modules 1100a, 1100b, and 1100c may have different fields of view from one another. In this case, the camera modules 1100a, 1100b, and 1100c may have different optical lenses, but the present disclosure is not limited thereto.

In some example embodiments, the camera modules 1100a, 1100b, and 1100c may be physically separate from one another. That is, the sensing area of the image sensor 1142 is not divided and shared between the camera modules 1100a, 1100b, and 1100c, but multiple independent image sensors 1142 may be provided in the camera modules 1100a, 1100b, and 1100c.

Referring again to FIG. 11, the application processor 1200 may include an image processing device 1210, a memory controller 1220, and an internal memory 1230. The application processor 1200 may be implemented separately from the camera modules 1100a, 1100b, and 1100c. For example, the application processor 1200 and the camera modules 1100a, 1100b, and 1100c may be implemented in different semiconductor chips.

The image processing device 1210 may include a plurality of sub-image processors, for example, sub-image processors 1212a, 1212b, and 1212c, an image generator 1214, and a camera module controller 1216.

The image processing device 1210 may include as many sub-image processors as there are camera modules.

Image data generated by the camera modules 1100a, 1100b, and 1100c may be provided to the sub-image processors 1212a, 1212b, and 1212c through image signal lines ISLa, ISLb, and ISLc, which are separate from one another. For example, image data generated by the camera module 1100a may be provided to the first sub-image processor 1212a through the first image signal line ISLa, image data generated by the camera module 1100b may be provided to the second sub-image processor 1212b through the second image signal line ISLb, and image data generated by the third camera module 1100c may be provided to the third sub-image processor 1212c through the third image signal line ISLc. The transmission of these image data may be performed using, for example, a Mobile Industry Processor Interface Camera Serial Interface (MIPI CSI), but the present disclosure is not limited thereto.

In some example embodiments, one sub-image processor may be disposed to correspond to multiple camera modules. For example, the sub-image processors 1212a and 1212c may not be separate from each other, but may be incorporated into a single sub-image processor, and image data provided by the camera modules 1100a and 1100c may be selected by a selection element (e.g., a multiplexor) and then provided to the single sub-image processor.

Image data provided to the sub-image processors 1212a, 1212b, and 1212c may be provided to the image generator 1214. The image generator 1214 may generate an output image using the image data provided by the sub-image processors 1212a, 1212b, and 1212c, in accordance with image generation information or a mode signal.

For example, the image generator 1214 may generate the output image by merging at least parts of image data generated by camera modules 1100a, 1100b, and 1100c having different fields of view, in accordance with the image generation information or the mode signal. Alternatively, the image generator 1214 may generate the output image by selecting one of the image data generated by the camera modules 1100a, 1100b, and 1100c having different fields of view, in accordance with the image generation information or the mode signal.

In some example embodiments, the image generation information may include a zoom signal or a zoom factor. In some example embodiments, the mode signal may be based on a mode selected by a user.

When the image generation information includes a zoom signal or a zoom factor and the camera modules 1100a, 1100b, and 1100c have different fields of view, the image generator 1214 may perform different operations in accordance with different types of zoom signals. For example, when the zoom signal is a first signal, the image generator 1214 may merge image data output from the camera module 1100a and image data output from the third camera module 1100c and may generate an output image using the merged image data and image data output from the camera module 1100b, not merged with the image data output from the camera module 1100a and 1100c. When the zoom signal is a second signal different from the first signal, the image generator 1214 may generate an output image by selecting one of the image data output from the camera modules 1100a, 1100b, and 1100c, instead of merging the image data output from the camera modules 1100a, 1100b, and 1100c. However, the disclosure is not limited to this, and a method to process image data may vary whenever necessary.

In some example embodiments, the image generator 1214 may receive image data having different exposure times from at least one of the sub-image processors 1212a, 1212b, and 1212c and may perform high dynamic range (HDR) processing on the received image data, thereby generating merged image data having an increased dynamic range.

The camera module controller 1216 may provide control signals to the camera modules 1100a, 1100b, and 1100c. Control signals generated by the camera module controller 1216 may be provided to the camera modules 1100a, 1100b, and 1100c through the control signal lines CSLa, CSLb, and CSLc, respectively, which are separate from one another.

One of the camera modules 1100a, 1100b, and 1100c, for example, the camera module 1100b, may be designated as a master camera, and the other camera modules, e.g., the camera modules 1100a and 1100c, may be designated as slave cameras, in accordance with a mode signal or image generation information including a zoom signal. The mode signal and the image generation information may be included in control signals and may be provided to the camera modules 1100a, 1100b, and 1100c through the control signal lines CSLa, CSLb, and CSLc, respectively, which are separate from one another.

Camera modules that operate as a master and as a slave may change in accordance with a zoom factor or an operating mode signal. For example, if the camera module 1100a has a wider field of view than the camera module 1100b and the zoom factor has a low zoom ratio, the camera module 1100b may operate as a master, and the camera module 1100a may operate as a slave. On the contrary, if the zoom factor has a high zoom ratio, the camera module 1100a may operate as a master, and the camera module 1100b may operate as a slave.

In some example embodiments, the control signals provided from the camera module controller 1216 to the camera modules 1100a, 1100b, and 1100c may include a sync enable signal. For example, if the camera module 1100a is a master camera and the camera modules 1100a and 1100c are slave cameras, the camera module controller 1216 may transmit the sync enable signal to the camera module 1100b, and the camera module 1100b may generate a sync signal based on the sync enable signal and provide the sync signal to the camera modules 1100a and 1100c via sync signal lines SSL. The camera modules 1100a, 1100b, and 1100c may be synchronized with the sync signal and may thus transmit image data to the application processor 1200.

In some example embodiments, the control signals provided from the camera module controller 1216 to the camera modules 1100a, 1100b, and 1100c may include mode information. The camera modules 1100a, 1100b, and 1100c may operate in a first or second operating mode, which is associated with sensing speed, based on the mode information.

In the first operating mode, the camera modules 1100a, 1100b, and 1100c may generate image signals at a first speed (or a first frame rate), may encode the image signals at a second speed (or a second frame rate) higher than the first speed (or the first frame rate), and may transmit the encoded image signals to the application processor 1200. The second speed may be 30 times or less the first speed.

The application processor 1200 may store received image signals, e.g., encoded image signals, in the internal memory 1230, which is inside the application processor 1200, or in the external memory 1400, which is outside the application processor 1200. Thereafter, the application processor 1200 may read the encoded image signals from the internal memory 1230 or from the external memory 1400, may decode the encoded image signals, and may display image data generated based on the decoded image signals. For example, the sub-image processors 1212a, 1212b, and 1212c of the image processing device 1210 may decode encoded image signals from the camera modules 1100a, 1100b, and 1100c, respectively, and may process the decoded image signals.

In the second operating mode, the camera modules 1100a, 1100b, and 1100c may generate image signals at a third speed (or a third frame rate), which is lower than the first speed (or the first frame rate) and may transmit the image signals to the application processor 1200. Here, the image signals may be unencoded signals. The application processor 1200 may perform image processing on the image signals or may store the image signals in the internal memory 1230 or in the external memory 1400.

The PMIC 1300 may provide power (e.g., power supply voltages) to the camera modules 1100a, 1100b, and 1100c. For example, the PMIC 1300 may provide first power, second power, and third power to the camera modules 1100a, 1100b, and 1100c, respectively, through power signal lines PSLa, PSLb, and PSLc, respectively.

The PMIC 1300 may generate power corresponding to each of the camera modules 1100a, 1100b, and 1100c and adjust the level of the power in response to a power control signal PCON from the application processor 1200. The power control signal PCON may include power adjustment signals for different operating modes of the camera modules 1100a, 1100b, and 1100c. For example, the operation modes of the camera modules 1100a, 1100b, and 1100c may include a low power mode, and the power control signal PCON may include information regarding camera modules operating in the low power mode and the level of power set for the low power mode. The levels of power provided to the camera modules 1100a, 1100b, and 1100c may be the same or may differ from one another. The levels of power provided to the camera modules 1100a, 1100b, and 1100c may be dynamically changed.

When the terms “about” or “substantially” are used in this specification in connection with a numerical value, it is intended that the associated numerical value includes a manufacturing or operational tolerance (e.g., ±10%) around the stated numerical value. Moreover, when the words “generally” and “substantially” are used in connection with geometric shapes, it is intended that precision of the geometric shape is not required but that latitude for the shape is within the scope of the disclosure. Further, regardless of whether numerical values or shapes are modified as “about” or “substantially,” it will be understood that these values and shapes should be construed as including a manufacturing or operational tolerance (e.g., ±10%) around the stated numerical values or shapes.

As described herein, any electronic devices and/or portions thereof according to any of the example embodiments may include, may be included in, and/or may be implemented by one or more instances of processing circuitry such as hardware including logic circuits; a hardware/software combination such as a processor executing software; or any combination thereof. For example, the processing circuitry more specifically may include, but is not limited to, a central processing unit (CPU), an arithmetic logic unit (ALU), a graphics processing unit (GPU), an application processor (AP), a digital signal processor (DSP), a microcomputer, a field programmable gate array (FPGA), and programmable logic unit, a microprocessor, application-specific integrated circuit (ASIC), a neural network processing unit (NPU), an Electronic Control Unit (ECU), an Image Signal Processor (ISP), and the like. In some example embodiments, the processing circuitry may include a non-transitory computer readable storage device (e.g., a memory), for example a DRAM device, storing a program of instructions, and a processor (e.g., CPU) configured to execute the program of instructions to implement the functionality and/or methods performed by some or all of any devices, systems, modules, units, controllers, circuits, architectures, and/or portions thereof according to any of the example embodiments, and/or any portions thereof.

Embodiments of the present disclosure have been described above with reference to the accompanying drawings, but the present disclosure is not limited thereto and may be implemented in various different forms. It will be understood that the present disclosure can be implemented in other specific forms without changing the technical spirit or gist of the present disclosure. Therefore, it should be understood that the embodiments set forth herein are illustrative in all respects and not limiting.

1. An image sensing device comprising:
an image sensor configured to output a raw image by capturing an image of a subject; and
an image signal processor configured to
perform a bad pixel correction process on the raw image on an image patch-by-image patch unit,
determine a state of local saturation of an image patch of the raw image based on a number of saturated pixels whose pixel values exceed a local saturation threshold value, and
output a corrected image patch, which is obtained by correcting a pixel of the image patch with a corrected pixel value, with a replacement pixel value, or with a raw pixel value depending on the state of local saturation of the image patch.

2. The image sensing device of claim 1, wherein the image signal processor is configured to
determine the image patch is not locally saturated based on the number of saturated pixels being equal to or less than a first threshold value,
determine the image patch is locally saturated based on the number of saturated pixels being greater than the first threshold value and being equal to or less than a second threshold value, and
determine the image patch is burnt based on the number of saturated pixels being greater than the second threshold value.

3. The image sensing device of claim 2, wherein the image signal processor is configured to store location information of the saturated pixels based on the image patch being determined as locally saturated or burnt.

4. The image sensing device of claim 3, wherein the image signal processor is configured to correct a pixel value with the replacement pixel based on the image patch being determined as locally saturated and a center pixel of the image patch being included in the location information of the saturated pixels.

5. The image sensing device of claim 4, wherein the image signal processor is configured to obtain the replacement pixel value by multiplying a largest pixel value around the center pixel by a white balance ratio of the center pixel.

6. The image sensing device of claim 3, wherein the image signal processor is configured to correct pixel values of the saturated pixels with corresponding raw pixel values from the image patch.

7. The image sensing device of claim 1, wherein the image signal processor is configured to perform the bad pixel correction process on the image patch based on a difference between a current pixel value of a center pixel of the image patch and an ideal center pixel value exceeding a correction threshold value.

8. An operating method of an image signal processor, comprising:
receiving a raw image and image information regarding the raw image from an image sensor;
generating corrected pixel values by performing bad pixel correction on the raw image on an image patch-by-image patch basis;
determining a state of local saturation of an image patch of the raw image;
correcting the image patch with the corrected pixel values, with a replacement pixel value, or with raw pixel values depending on the state of local saturation of the image patch; and
outputting the corrected image patch.

9. The operating method of claim 8, wherein the determining the state of local saturation of the image patch comprises comparing current pixel values of pixels included in the image patch with a local saturation threshold value and determining pixels whose current pixel values exceed the local saturation threshold value as saturated pixels.

10. The operating method of claim 9, wherein the determining the state of local saturation of the image patch further comprises determining that the image patch is locally saturated, based on a number of saturated pixels being greater than a first threshold value, and determining that the image patch is burnt, based on the number of saturated pixels being greater than a second threshold value, which is greater than the first threshold value.

11. The operating method of claim 10, wherein the determining the state of local saturation of the image patch further comprises determining that the image patch is not locally saturated based on the number of saturated pixels being equal to or less than the first threshold value, and outputting the corrected image patch by correcting the image patch only with the corrected pixel values.

12. The operating method of claim 10, wherein the determining the state of the local saturation of the image patch further comprises,
storing location information of the saturated pixels based on the image patch being determined as being locally saturated or as being burnt.

13. The operating method of claim 10, wherein the image information includes the local saturation threshold value, the first threshold value, and the second threshold value.

14. The operating method of claim 12, wherein the correcting the image patch includes
correcting a pixel value of a center pixel of the image patch with the replacement pixel value based on the center pixel being included in the stored location information of the saturated pixels.

15. The operating method of claim 8, wherein the replacement pixel value is obtained by,
selecting a pixel which has a largest pixel value among adjacent pixels to current pixel of the image patch,
multiplying the largest pixel value by a white balance ratio of the center pixel of the image patch, and
outputting the multiplied value as the replacement pixel value.

16. The operating method of claim 13, wherein the image patch includes
restoring pixel values of the saturated pixels to corresponding raw pixel values from the image patch based on the image patch being determined as burnt.

17. An image signal processor comprising:
a pixel corrector configured to perform a bad pixel correction process on a raw image on an image patch-by-image patch basis;
a local saturation monitor configured to
determine a state of local saturation of an image patch of the raw image based on a number of saturated pixels and
store location information of the saturated pixels; and
a color distortion restorer configured to output a corrected image patch by correcting pixel values of the saturated pixels with a replacement pixel value or with raw pixel values.

18. The image signal processor of claim 17, wherein the local saturation monitor is configured to count a number of saturated pixels in the image patch whose raw pixel values exceed a local saturation threshold value and determine that the image patch is locally saturated, based on the number of saturated pixels being equal to or greater than a first threshold value.

19. The image signal processor of claim 18, wherein the color distortion restorer is configured to correct a pixel value of a center pixel of the image patch with the replacement pixel value, based on the center pixel of the image patch being a saturated pixel and the image patch is a saturated image patch.

20. The image signal processor of claim 19, wherein the replacement pixel value is configured to,
select a pixel which has a largest pixel value among adjacent pixels to current pixel of the image patch,
multiply the largest pixel value by a white balance ratio of the center pixel of the image patch, and
output the multiplied pixel value as the replacement pixel value.

21-23. (canceled)
